(19) United States
(12) Patent Application Publication
(10) Pub. No.: US 2025/0326345 A1
(43) Pub. Date: Oct. 23, 2025

(54) VEHICLE ASSIST HANDLE HAVING INTERCHANGEABLE COVER

(71) Applicant: Ford Global Technologies, LLC, Dearborn, MI (US)

(72) Inventors: Diego Fabricio Villacres Mesias, Mexico City (MX); Joe Siler, Farmington, MI (US); Alejandra Rivas Franco, Huixquilucan (MX); Rodrigo Vicencio, Cuautitlán Izcalli (MX); Omar Ivan Sandoval Gonzalez, Hermosillo (MX)

(73) Assignee: Ford Global Technologies, LLC, Dearborn, MI (US)

(21) Appl. No.: 18/643,004

(22) Filed: Apr. 23, 2024

(51) Int. Cl. B60N 3/02

(52) U.S. Cl. CPC B60N 3/02

(57) ABSTRACT

An assist handle assembly for a vehicle, the assist handle assembly having a body configured to be connected to a structural support on the vehicle and a removable cover configured to engage and cover the body, wherein the removable cover is configured to be removed from the body and replaced with another removable cover.

### FIELD OF THE DISCLOSURE

The present disclosure generally relates to assist handles, and more particularly relates to a vehicle mounted assist handle assembly that is user customizable.

### BACKGROUND OF THE DISCLOSURE

Motor vehicles are commonly equipped with handle structures referred to as passenger assist handles for passengers to grasp with their hand when entering and exiting the vehicle and during maneuvering of the vehicle. Assist handles may be particularly useful for off-road-style vehicles while driving on rough road conditions. It may be desirable to provide for a user customizable arrangement of assist handles.

### SUMMARY OF THE DISCLOSURE

According to a first aspect of the present disclosure, an assist handle assembly for a vehicle, the assist handle assembly comprising a body configured to be connected to a structural support on the vehicle and a removable cover configured to engage and cover the body, wherein the removable cover is configured to be removed from the body and replaced with another removable cover.

Embodiments of the first aspect of the present disclosure can include any one or a combination of the following features:
the body comprises a honeycomb structure;
the honeycomb structure comprises a transversal honeycomb structure;
the body comprises a locator pin configured to engage the structural support in the vehicle and at least one fastener to fasten the body onto the support structure;
the cover is retained on the body with the one or more fasteners;
the cover comprises rubber;
the cover further comprises a rigid inner polymeric material;
the rubber may be over molded onto the rigid inner polymeric material;
the assist handle assembly is configured to be installed in a passenger compartment of the vehicle; and
the assist handle assembly is configured to be installed onto a support pillar in the interior of the vehicle.

According to a second aspect of the present disclosure, an assist handle assembly for use in an interior of a motor vehicle, the assist handle assembly comprising a rigid body configured to be connected to a structural support on the motor vehicle, a removable cover configured to engage and cover the rigid body, wherein the removable cover is configured to be removed from the rigid body and replaced with another removable cover, and one or more removable fasteners configured to retain the cover on the body.

Embodiments of the second aspect of the present disclosure can include any one or a combination of the following features:
the body comprises a honeycomb structure;
the honeycomb structure comprises a transversal honeycomb structure;
the body comprises a locator pin configured to engage the structural support in the motor vehicle;
the cover comprises rubber;
the cover further comprises a rigid inner polymeric material;
the rubber may be over molded onto the rigid inner polymeric material;
the assist handle assembly is configured to be installed in a passenger compartment of the motor vehicle; and
the assist handle assembly is configured to be installed onto a support pillar in the interior of the motor vehicle.

According to a third aspect of the present disclosure, a vehicle comprising an interior cabin, a support structure within the interior cabin, and an assist handle assembly installed in the interior cabin of the vehicle, the assist handle assembly comprising a rigid body configured to be connected to a structural support on the vehicle and a removable cover configured to engage and cover the body, wherein the removable cover is configured to be removed from the rigid body and replaced with another removable cover.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1 is a perspective view of a motor vehicle that is configured with a plurality of assist handle assemblies;

In the drawings:

FIG. 2A is an enlarged view of an assist handle assembly shown connected to a support pillar in the motor vehicle;

FIG. 2B is a perspective view of the assist handle assembly connected to the support pillar with the replaceable cover removed;

FIG. 2C is a perspective view of the assist handle assembly connected to the support pillar with a replacement cover exploded therefrom;

FIG. 2D is a perspective view of the assist handle assembly connected to the support pillar with the replacement cover assembled onto the rigid body of the assist handle;

FIG. 3 is an exploded view of the assist handle assembly showing the cover exploded from the body and having a soft outer cover layer and a rigid inner cover layer;

FIG. 4 is a cross-sectional view taken through line IV-IV of FIG. 2A illustrating the connection of one end of the assist handle assembly to the support pillar;

FIG. 5 is a cross-sectional view taken through line V-V of FIG. 2A illustrating the connection of the other end of the assist handle assembly;

FIG. 6 is a cross-sectional view taken through line VI-VI of FIG. 2A, further illustrating the cover assembled onto the rigid body;

FIG. 7 is a cross-sectional view taken through line VII-VII of FIG. 2A, further illustrating the cover assembled onto the rigid body; and

FIG. 8 is a cross-sectional view taken through line VIII-VIII of FIG. 2A, further illustrating the cover assembled onto the rigid body.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

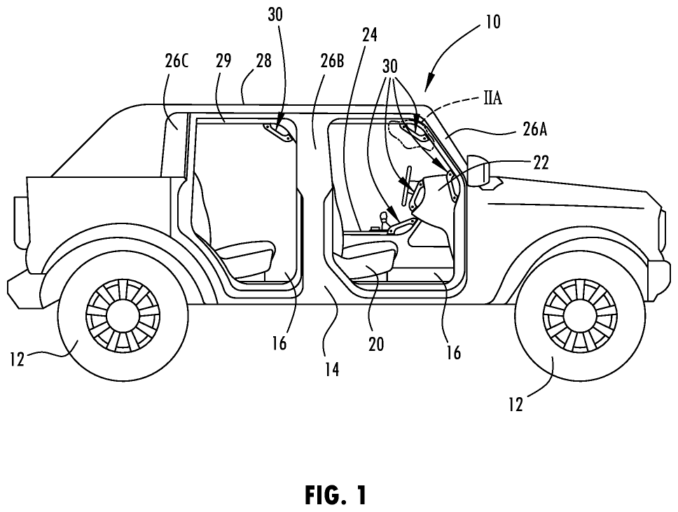

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle assist handle assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-9, a vehicle assist handle assembly 30 is illustrated assembled on a motor vehicle 10 having an underlying rigid structural body and a removable cover that overlays the rigid structural body and may readily be replaced such that the assist handle assembly 30 is customizable by a user of the motor vehicle 10. The assist handle assembly 30 has a shape and size configured to be gripped by a user's hand and is configured to secure the assist handle assembly 30 to a structural trim component or other support structure in the interior of the motor vehicle 10.

With particular reference to FIG. 1, the motor vehicle 10 is generally illustrated in one exemplary embodiment equipped with a plurality of assist handle assemblies 30 assembled at various locations within the interior of the motor vehicle 10. The motor vehicle 10 is generally shown in one example as an off-road style, wheeled motor vehicle that may be driven on a roadway or driven off-road on various types of terrain. The motor vehicle 10 generally includes a plurality of road wheels 12 and a vehicle body 14 generally defining a passenger compartment 18 on the interior with ingress/egress openings 16 which may be closed with doors. The doors may include hingedly connected door panels with windows or crossbars having exposed openings that may be fixedly installed or removable, according to various examples. While a wheeled motor vehicle 10 is generally shown and described herein, it should be appreciated that other vehicles such as boats, trains, planes and other vehicles may be equipped with the assist handle assembly 30.

The motor vehicle 10 is configured to include one or more seats 20 for holding passengers seated within the passenger compartment 18 of the motor vehicle 10. In a typical passenger vehicle seating arrangement, a front row of bucket seats may include two seats 20 spaced apart and the second row may have a bench seat or bucket seat configuration that may include a row of three seats or may include two seats separated by a rear center console. The front row seats 20 are generally located rearward of a dashboard 22. A front center console 24 is shown located centrally within the front row of seats 20 between a driver seat and a passenger seat. The center console 24 may be configured with storage compartments, drink holders and other features.

The motor vehicle 10 has support pillars shown including a pair of front support pillars 26A on opposite lateral sides, a pair of middle support pillars 26B on opposite lateral sides, and a pair of rear support pillars 26C on opposite lateral sides that generally extend from a lower frame to a roof 28 of the motor vehicle 10. The roof 28 may have headliner 29 on the underside. Assist handle assemblies 30 may be connected to the front support pillars 26A near the upper end where the front support pillars approach or join with the roof 28, according to one embodiment. Additional assist handle assemblies 30 may also be located on the middle support pillar 26B, on the center console 24, on the dashboard 22, and proximate the door opening 16.

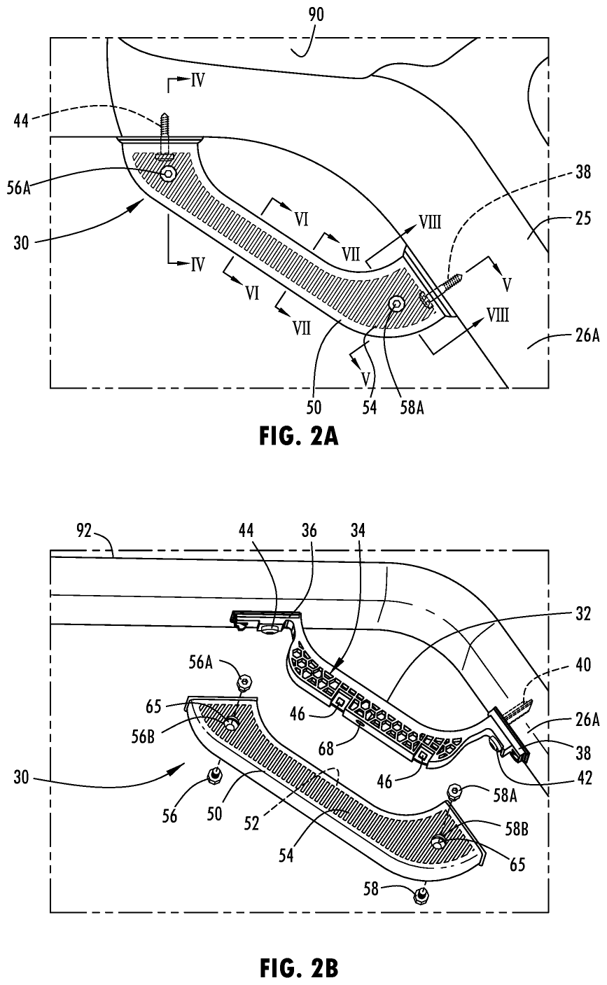

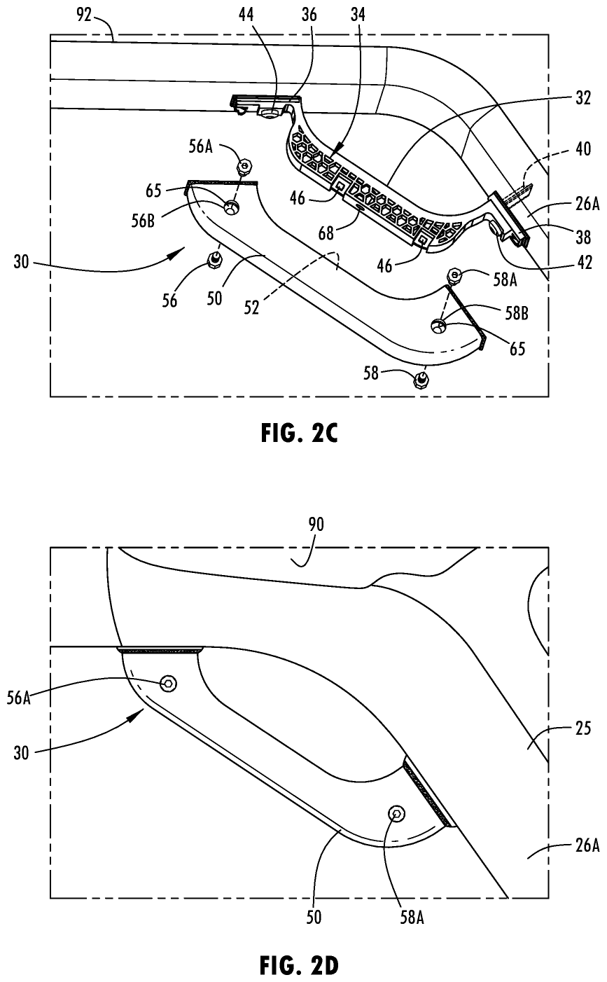

Referring to FIGS. 2A-2D, the assist handle assembly 30 are shown is assembled onto an upper end of one of the front support pillars 26A proximate to a portion that bends near the roof 28 and positioned to enable a passenger seated on seat 20 or entering or leaving the motor vehicle 10 to engage and grip the assist handle assembly 30 with a hand for support while entering or leaving the motor vehicle 10 and while traveling in the motor vehicle 10. For example, when the motor vehicle 10 is traveling off-road on rough terrain, a passenger seated on the passenger seat 20 may grip the assist handle assembly 30 for purposes of maintaining balance and stability. While the assist handle assembly 30 is shown in FIGS. 2A-2D located on the one side of the motor vehicle 10, it should be appreciated that the assist handle assembly 30 may be located on the opposite lateral side of the motor vehicle 10, on a rear or middle support pillar 26B, on the roof 28, on a passenger seat, on a center console, on a dashboard, in the rear row of seating such as on a rear center console, on a trim panel, or at other locations within the motor vehicle 10.

The assist handle assembly 30 includes a rigid handle body 32 that connects to a supporting structure which may include the front support pillar 26A or a trim component on the front support pillar 26A. The handle body 32 may be connected directly to the front support pillar 26A or indirectly via a trim component that in turn is connected to the front support pillar 26A. An assist handle cover 50 overlays the handle body 32 and is designed to receive and support a user's hand gripped thereto. The handle body 32 is connected to the support pillar 26A via fasteners as shown and described herein. The assist handle assembly 30 thereby serves as an assist handle.

The rigid handle body 32 is shown connected at one end to a lower portion of the front support pillar 26A and connected at the opposite end to an upper portion of the front support pillar 26A with a bend which forms a roof support 92. The handle body 32 is a generally rigid body having an elongated handle portion with a first base mount 38 at one end for connecting to the lower portion of the front support pillar 26A and a second base mount 36 at the opposite end for connecting to the upper portion of the front support pillar 26A which forms the roof support 92. The elongated handle portion of the rigid handle body 32 may be made of a transversal honeycomb structure 34, for example. The honeycomb structure 34 provides for a reduced weight configuration while maintaining sufficient strength and rigidity of the assist handle assembly 30. The rigid handle body 32 is configured to receive a cover 50 that may be replaceable by a user and thereby is customizable such as to provide a different pattern, color, shape, size, texture, etc.

The cover 50 is shown generally having a shape configured to overlay and cover the rigid handle body 32. The cover 50 as shown in FIGS. 2A and 2B is one example of a cover having a size, shape, pattern, texture, and grip structure on the outside surface sufficient to provide for suitable gripping by the hand of a user of the motor vehicle 10. The cover 50 may be made of an outer pliable polymeric material, such as a soft pliable rubber, in a first embodiment. The cover 50 may include a rigid inner portion that is separate from the soft outer layer, according to a second embodiment. In the second embodiment, the rigid inner portion may be over-molded with the soft outer layer. It should be appreciated that in some embodiments, the cover 50 may or may not include the rigid inner portion and may include only a soft outer layer.

The cover 50 is configured with an elongate opening 52 accessible on the innermost side and generally extending a substantial length of the handle cover that may receive the elongate shaped handle body 32 during assembly of the cover 50 onto the rigid handle body 30. An inner portion of the cover 50 may engage snapping features 46 provided on the rigid handle body 32 to engage and snap the cover 50 onto the handle body 32. The cover 50 may be attached onto the handle body 32 and clamped in a fixed position with a pair of fasteners 56 and 58, generally shown located proximate to opposite ends of the assist handle assembly 30. The cover 50 shown in FIGS. 2A and 2B may be removed and replaced with the cover 50 shown in FIGS. 2C and 2D having a different pattern, color, shape, size or texture, for example.

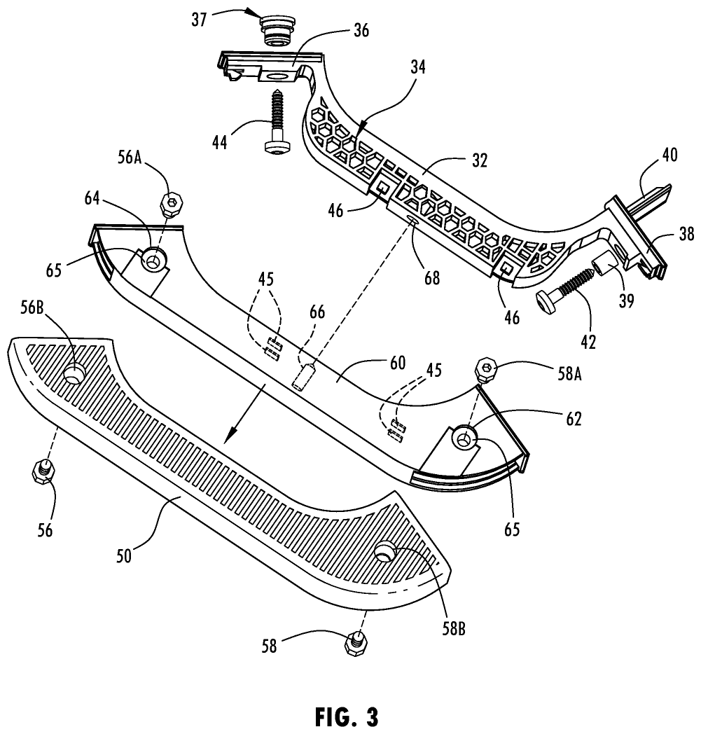

Referring to FIG. 3, one example of the assist handle assembly 30 having an outer soft pliable cover 50 and an underlying rigid intermediate body 60 is shown. It should be appreciated that the rigid intermediate body 60 may be inserted and assembled as a separate component into the cover 50 in one embodiment. In another embodiment, the intermediate rigid body 60 may be formed by over-molding the soft pliable outer cover 50 onto the outer surface of the intermediate rigid body 60.

The cover 50 and intermediate rigid body 60 both are shown having lateral extending openings 58B and 56B formed in cover 50 and aligned with openings 62 and 64 in the intermediate rigid body 60 for receiving the fasteners 58 and 56. The fasteners 56 and 58 may be bolts, for example, each having threading on one end configured to threadingly engage a nut. The fastener 58 may also include the nuts 58A and 56A on opposite sides of the cover 50, such that the fastener 58 may be fastened with the nuts 58A and 56A to fasten the cover 50 to clamp onto the rigid handle body 32 or unfastened to allow a user to remove the cover 50 from the rigid handle body 30.

A user of the motor vehicle 10 may easily disassemble the assist handle assembly 30 to remove a first cover 50 from the rigid handle body 32 by unfastening the fasteners 58 and 56 from the corresponding nuts 58A and 56A, disconnecting retention features and physically removing the first cover 50 from the rigid handle body 32. The user may then select and install a second cover 50 on top of the rigid handle body 32 and may fasten the second cover 50 onto the rigid handle body 32 by reconnecting retention features and installing fasteners 58 and 56 through holes 62 and 64 and connecting the corresponding nuts 58A and 56A on the ends. As such, the user may customize the assist handle assembly 30 by changing out the cover 50 with another cover having a desired color, pattern, texture, shape, size, and other features that are desirable to a user to thereby customize the motor vehicle 10.

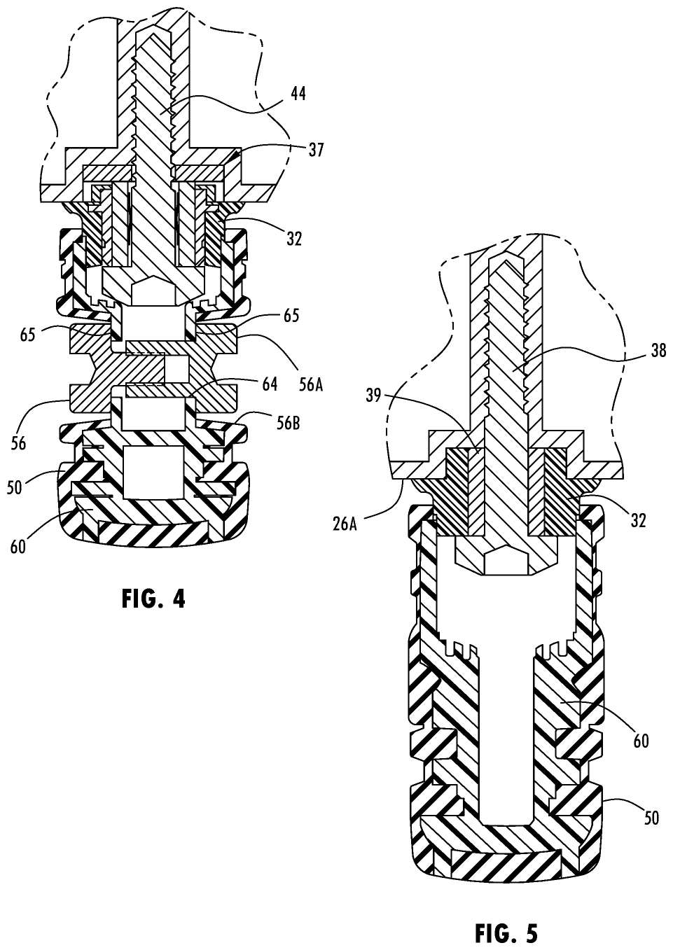

The rigid handle body 32 is shown in FIG. 3 with connectors on opposite ends for connecting to a structural component of the vehicle interior such as the front support pillar. As seen in FIGS. 3 and 4, the upper end of the rigid handle body 32 has a fastener 44 that extends through a hole in the first base end 36 and engages a tolerance compensator assembly 37 and supporting structure. The second base end 38 of the rigid handle assembly 32 has a locator pin 40 for alignment and receives fastener 42 which engages a metallic compression limiter assembly 37 and the underlying supporting structure for supporting the rigid handle assembly 32. Accordingly, fasteners 42 and 44 rigidly connect the rigid handle assembly 32 onto a structural component such as the front pillar assembly, according to one example.

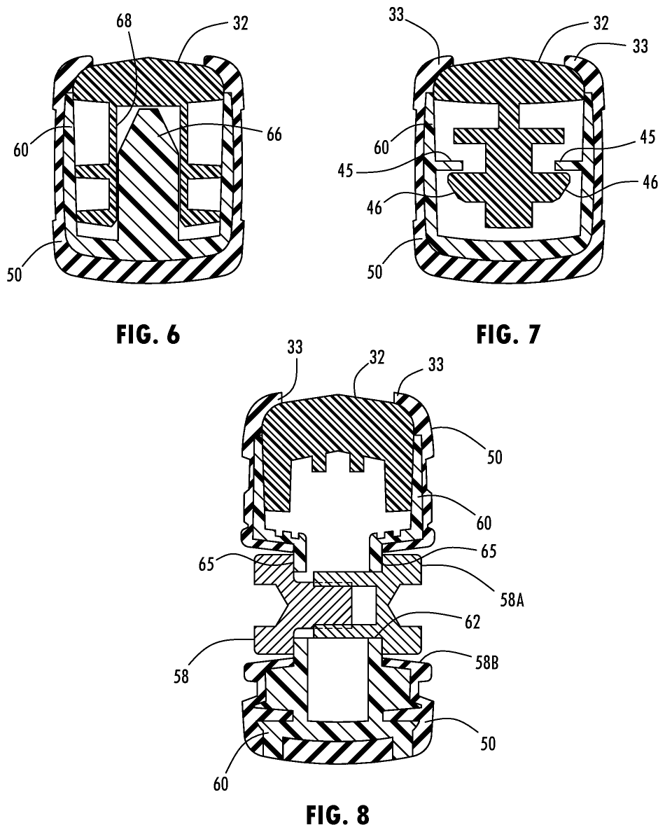

The cover 50 with the intermediate or inner rigid portion 60 is shown having an oval shape alignment pin 66 for engaging an oval hole 68 as shown in FIGS. 3 and 6. This allows for the cover 50 to be easily aligned with the rigid handle body 32 during assembly of the cover 50 onto the rigid body handle 32.

The rigid body handle 32 includes a pair of snap features 46 which are configured to receive alignment and stamp features of the cover 50 and intermediate layer 60 as seen in FIG. 7. The cover 50 and rigid intermediate layer 60 have a pair of inward extending fingers 45 on opposite sides that engage within a space defined by the snap feature 46. Additionally, the cover 50 and intermediate layer 60 have a pair of retention features in the form of lips 33 on opposite ends proximate to the opening 52. As such, a user may bend to deform the cover 50 and intermediate layer 60 to move the retention lips 33 and fingers 45 outward to disassemble the cover 50 from the rigid body handle 32 or assemble it onto the rigid handle body 32. The cover 50 and inner layer 60 have memory that returns the retention lips 33 and fingers 45 inward into engagement with the snap feature 46 and the corners of the rigid handle body 32.

Once the cover 50 and inner layer 60 are retained on the rigid handle body 32 via fingers 45 and retention lips 33, the bolts 56 and 58 may be assembled onto corresponding nuts 58A and 58B which when tightened engage clamping surfaces 65 which are formed as lips as shown in FIG. 8. As the fasteners engage the nuts and are fastened down, they provide a clamping force on the clamping surfaces 65 to prevent removal of the cover 50 from the rigid handle body 32. As a result, the cover 50 is rigidly clamped onto the rigid handle body 32. A user may remove the fasteners 58 and 60 and remove the engagement of the retention lips 33 and fingers 45 from the rigid handle body 32 to remove the cover 50 and may repeat the process to reinstall a new cover 50, thereby offering a customizable assist handle assembly.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An assist handle assembly for a vehicle, the assist handle assembly comprising:
a body configured to be connected to a structural support on the vehicle; and
a removable cover configured to engage and cover the body, wherein the removable cover is configured to be removed from the body and replaced with another removable cover.

2. The assist handle assembly of claim 1, wherein the body comprises a honeycomb structure.

3. The assist handle assembly of claim 2, wherein the honeycomb structure comprises a transversal honeycomb structure.

4. The assist handle assembly of claim 1, wherein the body comprises a locator pin configured to engage the structural support in the vehicle and at least one fastener to fasten the body onto the support structure.

5. The assist handle assembly of claim 1, wherein the cover is retained on the body with the one or more fasteners.

6. The assist handle assembly of claim 1, wherein the cover comprises rubber.

7. The assist handle assembly of claim 6, wherein the cover further comprises a rigid inner polymeric material.

8. The assist handle assembly of claim 7, wherein the rubber may be over molded onto the rigid inner polymeric material.

9. The assist handle assembly of claim 1, wherein the assist handle assembly is configured to be installed in a passenger compartment of the vehicle.

10. The assist handle assembly of claim 9, wherein the assist handle assembly is configured to be installed onto a support pillar in the interior of the vehicle.

11. An assist handle assembly for use in an interior of a motor vehicle, the assist handle assembly comprising:
a rigid body configured to be connected to a structural support on the motor vehicle;
a removable cover configured to engage and cover the rigid body, wherein the removable cover is configured to be removed from the rigid body and replaced with another removable cover; and
one or more removable fasteners configured to retain the cover on the body.

12. The assist handle assembly of claim 11, wherein the body comprises a honeycomb structure.

13. The assist handle assembly of claim 12, wherein the honeycomb structure comprises a transversal honeycomb structure.

14. The assist handle assembly of claim 11, wherein the body comprises a locator pin configured to engage the structural support in the motor vehicle.

15. The assist handle assembly of claim 11, wherein the cover comprises rubber.

16. The assist handle assembly of claim 15, wherein the cover further comprises a rigid inner polymeric material.

17. The assist handle assembly of claim 16, wherein the rubber may be over molded onto the rigid inner polymeric material.

18. The assist handle assembly of claim 11, wherein the assist handle assembly is configured to be installed in a passenger compartment of the motor vehicle.

19. The assist handle assembly of claim 18, wherein the assist handle assembly is configured to be installed onto a support pillar in the interior of the motor vehicle.

20. A vehicle comprising:
an interior cabin;
a support structure within the interior cabin; and
an assist handle assembly installed in the interior cabin of the vehicle, the assist handle assembly comprising:
a rigid body configured to be connected to a structural support on the vehicle; and
a removable cover configured to engage and cover the rigid body, wherein the removable cover is configured to be removed from the rigid body and replaced with another removable cover.
